(19) United States
(12) Patent Application Publication
(10) Pub. No.: US 2021/0102755 A1
(43) Pub. Date: Apr. 8, 2021

(54) OVEN CAMERA

(71) Applicant: TurboChef Technologies, LLC, Carrollton, TX (US)

(72) Inventor: James K. Pool, III, Frisco, TX (US)

(21) Appl. No.: 17/063,282

(22) Filed: Oct. 5, 2020

Related U.S. Application Data
(60) Provisional application No. 62/910,816, filed on Oct. 4, 2019.

(51) Int. Cl. F27D 21/02; H04N 7/18; H04N 5/247; H04N 5/225; F24C 15/00

(52) U.S. Cl. CPC F27D 21/02; H04N 7/18; F27D 2021/026; H04N 5/2253; F24C 15/00; H04N 5/247

(57) ABSTRACT

Externally-positioned cameras for use with ovens. The cameras may be provided as a single camera or as a plurality of cameras. In one example, the camera image a food item entering an oven and help set cooking parameters for the food item.

### CROSS REFERENCE TO RELATED APPLICATIONS

This application is related to and claims priority benefits from U.S. Provisional Application Ser. No. 62/910,816, filed on Oct. 4, 2019, entitled “Oven Camera,” the entire contents of each of which are hereby incorporated by this reference.

### FIELD OF THE DISCLOSURE

Embodiments of the present disclosure relate generally to externally-positioned cameras for use with ovens.

### BACKGROUND

Various companies have sought to employ cameras in connection with ovens. To date, one exemplary use of these cameras is that they have been mounted inside the oven cavity and are used to monitor a cooking cycle. These cameras can communicate with technology that can recognize food items that are placed within the cooking cavity set or adjust various cooking parameters to begin or alter the cooking cycle in order to optimize oven functions. Other uses of these cameras may be to alert an operator when the oven is not configured correctly. For example, a certain cooking parameter may require a food item to be positioned at a certain height within the oven, and the camera can communicate with technology that can alert the operator that a change may need to be made based on the food position.

In these instances, the internally-mounted cameras are used with ovens that do not employ internal conditions that are damaging to the camera. However, certain types of ovens may use cooking conditions that make use of an internal camera impractical or impossible. For example, some rapid cooking ovens that use microwave energy, blow hot air at a high velocity, at continuous high temperatures, can create grease splatter, combinations thereof, or otherwise provide cooking energy in a relatively aggressive environment.

In these types of ovens, use of an internal camera would generally require the camera to be covered in some fashion, such as via a perforated screen to protect it from RF radiation from the microwaves and a clear aperture that would protect the camera's lens that could be positioned in front of the camera. Additionally or alternatively, because these types of ovens blow hot air at a high velocity, there may be grease splatter that could cover a camera lens. At some point during the cooking process, the camera can lose effectiveness and need to be cleaned. However, cleaning a camera used in this type of cooking environment would generally need a high frequency of cleaning and require a fairly aggressive type of cleaner and/or would generally require the oven to cool down for safety reasons and remain out of service during the cleaning process. The oven would then have to be reheated before it can be returned to operation. This is not optimal. Additionally, frequent cleaning of the protective cover could also damage the cover over time, thus rendering the camera unable to recognize the food item.

### BRIEF SUMMARY

This disclosure relates to the use of one or more externally-positioned cameras on an oven. The one or more cameras may be used to capture an image of a food item as it is positioned (moved) into the oven. One or more cooking parameters may be set based on the type of food imaged.

In one example, there is provided an oven, comprising an oven housing; and one or more cameras associated with an external surface of the oven housing, wherein the one or more cameras are configured to image a food/item/tray as it is positioned or otherwise moved into the oven. The oven may have a control panel adjacent the oven external surface; and one or more cameras may be associated with the control panel. The one or more cameras may be associated with a lower portion of the control panel. The one or more cameras may be integrated into the control panel. The one or more cameras may be mounted to a lower surface of the control panel. The one or more cameras may be positioned on an external panel. The one or more cameras may be associated with an upper area of the oven housing at a location at which an oven door locks against the oven housing.

In a specific example, more than one camera is provided. For example, a first camera may be used to image a top view of a food item as it is positioned within the oven cavity, and a second camera may be used to image at least a portion of a side view of the food item as it is positioned within the oven cavity. This is necessary as some foods, such as a closed sandwich would look similar from the top looking camera.

A further embodiment provides a method for setting oven cooking parameters, comprising: providing an oven with one or more externally-positioned cameras; imaging a food item as it is positioned within the oven; and setting one or more cooking parameters of the oven based on the image captured. The one or more externally-positioned cameras may communicate with a control panel in order to set the one or more cooking parameters.

In another embodiment, the one or more cameras may image the food as it positioned into the oven's cavity and make a suggestion as to the type of food that is about to be cooked. If the suggestion item is confirmed by the operator, the oven's control system learns that the particular item is associated with a specific cook setting within the oven's memory and subsequent cooks do not require user interaction or confirmation.

### BRIEF DESCRIPTION OF THE FIGURES

FIG. 1 shows a front plan view of an oven having a camera associated with a control panel.

FIG. 2 shows a front plan view of an oven having two cameras associated with a control panel.

FIG. 3 shows a side cross sectional view of the oven of FIG. 1.

FIG. 4 shows a side plan view of the oven of FIG. 1 in an open configuration.

FIG. 5 shows a side plan view schematic of an oven having a camera positioned at an upper area of the oven housing.

### DETAILED DESCRIPTION

Embodiments of the present disclosure thus provide one or more cameras for use in connection with an oven, wherein the one or more cameras are positioned externally to the oven cooking cavity. (Although this disclosure relates to use of a single camera, or a plurality of cameras, it should be understood that use of the singular term “camera” should also be interpreted to be “one or more cameras” when appropriate.) In a specific embodiment, one or more cameras are associated with the oven control panel or with an external panel/bracket. The one or more cameras may be integrally formed into the control panel and/or the one or more cameras may be mounted directly below the control panel. In other examples, the one or more cameras may be mounted externally and adjacent to a cooking surface. For example, one or more cameras may be positioned such that the camera faces down, toward food items as they are positioned within or moved into the oven cooking cavity. As the food is passed or moved into the oven, the food necessarily also moves past the one or more cameras. The camera or plurality of cameras may capture an image. The image may be focused on the food item itself, on the type of tray on which the food item is positioned, or any other feature that can be captured.

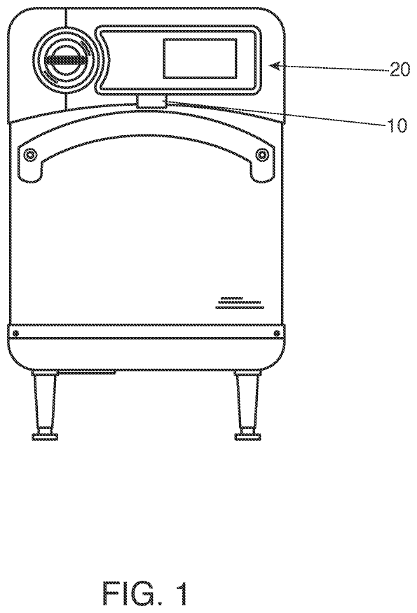

In embodiments that use a single camera, the camera 10 may be positioned generally centrally below the control panel 20 or otherwise above a cooking cavity opening, as illustrated by FIG. 1. This camera may be positioned o that it can capture a top view of the food item as it passes the camera. In embodiments that use more than one camera, the cameras 10 may be positioned evenly below the control panel 20, randomly below the control panel 20, or any other configuration.

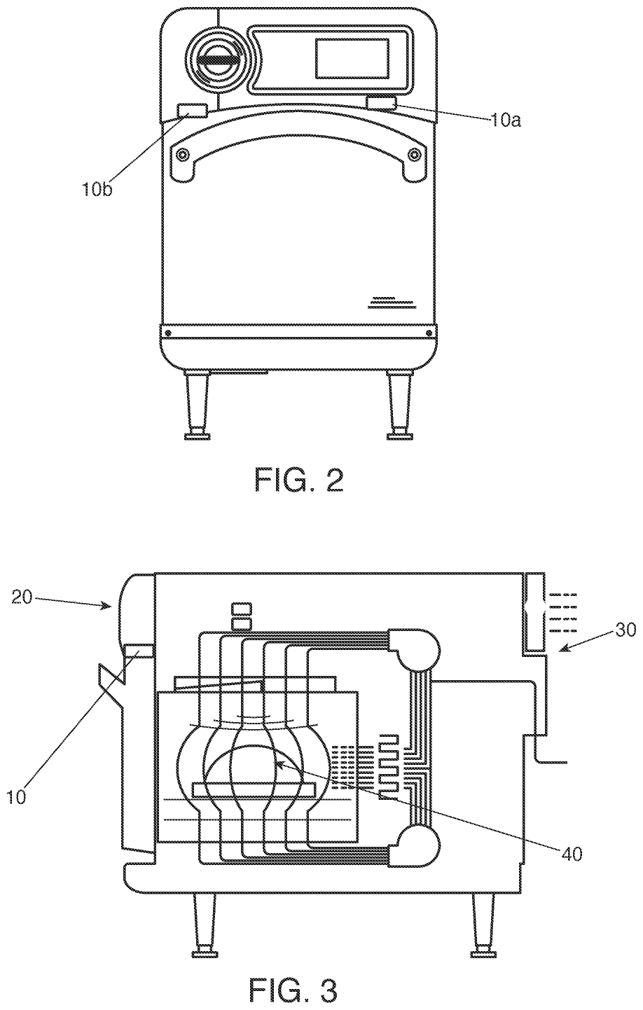

Additionally or alternatively, the one or more cameras may be positioned near a side of the oven so that it captures a side view of the food item. In a specific example, it may be desirable to provide at least two cameras. This can allow a first camera 10a to image a top view of the food item/tray configuration and a second camera 10b to be positioned at an angle such that it can image a side or other view of the food item/tray configuration. One example of this configuration is illustrated by FIG. 2. This illustrated configuration is exemplary only. For example, it is also possible to provide a top view camera, a side view camera, and/or a lower view camera, or any combination thereof. A top and bottom camera may be provided. A bottom and side camera may be provided. A top and side camera may be provided. A top and two side camera may be provided. These examples are provided for illustration only. It should be understood that additional cameras may be added to obtain additional views to aid in the recognition of food items that look similar or identical from the top. For example, a bacon/egg/cheese croissant may look the same as a sausage/egg/cheese croissant from the top. However, although they are both contained within a croissant and would look the same from the top, the bacon may require different cooking parameters than the sausage. Accordingly, providing a second or additional camera that can capture a side image of the food item can help improve automatic cooking programming. It should be also be understood that the cameras 10a, 10b may be positioned more closely together or farther apart. It should further be understood that a single camera may be able to take multiple views.

FIG. 3 illustrates a side view of an oven 30 having one or more cameras 10 positioned within or otherwise associated with the control panel 20, such that they face downward and can image a food item/tray configuration as it is positioned within the oven cavity 40 and passes below the control panel 20.

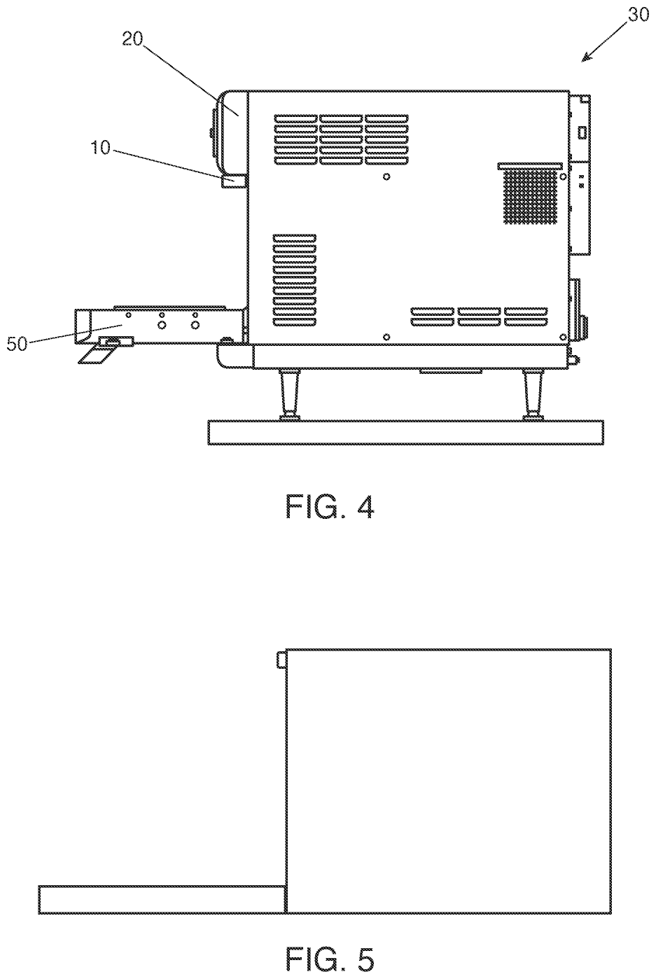

FIG. 4 illustrates an oven 30 with the oven door 50 in an open configuration, illustrating a camera 10 positioned below the control panel 20 or otherwise above or adjacent to the oven cooking cavity opening.

One feature of the oven cameras described herein is that they can be used to help automate the cooking process. For example, an oven may be “taught” or pre-programmed by artificial intelligence with a number of known food images in order to train the oven to automatically set cooking parameters. This artificial intelligence can help the oven system to match an image of a food item with a known cooking parameter in order to automatically program the oven with the correct cooking temperature, time, cooking type, etc. for that particular food item. In a specific example, once the oven is pre-programmed, it may continue to “learn” once it is in use at a food service location. For example, when the oven recognizes a particular food item and associates the food item with this image library, it can ask or suggest to the user that the food item is a “bacon/egg/cheese croissant,” and the user may select “yes”/“agree” or otherwise confirm the oven's suggestion. The appropriate cooking parameters are then applied. Once this process takes place a number of times at a specific food service location, the oven may then be completely customized for that food service location or it can be networked to provide all similar ovens in the network with the learning acquired, without requiring the user to continue to select “yes.” This can be beneficial because the stock food item images used to preprogrammed the oven may differ from the way that the actual food items look in use. Food Service Location A may allow its cheese to hang out the sides of its croissant more than Food Service Location B. Accordingly, the oven used at Location A may learn slightly differently than the oven used at Location B. This is one benefit of providing the disclosed oven cameras. They allow the oven to recognize specific food items that are specific to a particular food service location's menu.

In summary, it has been found by positioning a single camera or a plurality of cameras along or within a lower or bottom side of a control panel can allow the camera(s) to image food as it passes under the control panel into the oven cavity. The image(s) obtained can be used to program the oven automatically. In one example, a top image may be captured that indicates that the food item being positioned within the oven is a croissant vs. a bagel. Aside image may be captured that indicates that the food item within the particular pastry is an egg and cheese sandwich vs. a sausage and ham sandwich. A croissant versus a bagel will have a different cooking parameter, and an egg and cheese sandwich versus a sausage and ham sandwich may also have a different cooking parameter. By use of the above-disclosed artificial intelligence, pre-programming of the oven with stock food items and specific cooking parameters, then by individually “teaching” the oven in use about specific food items of a specific food service location, the oven can learn to automatically recognize the food item and set a specific cooking parameter. Similarly, a hoagie will have a different cooking parameter than a single serve cheese pizza, which will have a different cooking parameter than a full-size meat pizza. (These examples are obviously being provided for exemplary purposes only and are not intended to be limiting to the types of food items that may be imaged using this disclosed technology.)

In general, the image(s) obtained can indicate what food item is being positioned within the oven cavity. The oven may be preprogrammed with a series of cooking parameters for various types of food items that may be cooked. For example, a pastry or bread type may trigger a first type of cooking parameter. The interior of the pastry of bread or topping of the pastry or bread may trigger a second or different type of cooking parameter. These may be pre-set custom cooking cycles or cooking parameters. Once the image is related to the cooking system and the cooking system identifies a particular food item, then a cooking parameter to be used for the type of food item may be assigned. The oven may then be automatically set to begin the appropriate cycle upon closure of the oven door. This programming may take place via preprogrammed artificial intelligence during manufacturing of the oven, or remotely relying on the oven's connectivity, and reinforced via in use “learning” and confirmation on site.

One of the benefits of this disclosure means that a particular food establishment need not train its employees in various cooking options to be entered on the control panel of the oven. Instead, the employee(s) could have a very limited ability, including having limited to no vision, and still be able to operate the oven.

Additionally, although ovens are currently provided with control panels, it is conceivable that the control panel may be done away with in future ovens or positioned elsewhere. In this instance, the one or more cameras may be positioned along an external upper edge of the oven cavity, for example, at the point at which the oven door meets the outer oven frame. A schematic of this option is illustrated by FIG. 5.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Changes and modifications, additions and deletions may be made to the structures and methods recited above and shown in the drawings without departing from the scope or spirit of the invention disclosure and the following claims.

What is claimed is:

1. A oven comprising,
an oven housing; and
one or more cameras associated with an external surface of the oven housing, wherein the one or more cameras are configured to image a food/item/tray as it is positioned or otherwise moved into the oven.

2. The oven of claim 1, further comprising,
a control panel adjacent the oven external surface; and
one or more cameras associated with the control panel.

3. The oven of claim 2, wherein the one or more cameras are associated with a lower portion of the control panel.

4. The oven of claim 3, wherein the one or more cameras associated with the lower portion of the control panel are integrated into the control panel.

5. The oven of claim 3, wherein the one or more cameras associated with the lower portion of the control panel are mounted to a lower surface of the control panel.

6. The oven of claim 1, wherein the one or more cameras are positioned on an external panel.

7. The oven of claim 1, wherein the one or more cameras are associated with an upper area of the oven housing at a location at which an oven door locks against the oven housing.

8. The oven of claim 1, wherein the one or more cameras are positioned such that a first camera images a top view of a food item as it is moved into the oven cavity, and wherein a second camera images at least a portion of a side view of the food item as it is moved into the oven cavity.

9. A method for setting oven cooking parameters, comprising:
providing an oven with one or more externally-positioned cameras;
imaging a food item as it is positioned within the oven;
setting one or more cooking parameters of the oven based on the image captured.

10. The method of claim 9, wherein the one or more externally-positioned cameras communicate with a control panel in order to set the one or more cooking parameters.

11. A method of using artificial intelligence to set a cooking parameter, comprising,
capturing a food image as a food item is moved into an oven cooking cavity;
making a suggestion to an operator about the type of food that is about to be cooked;
requiring an operator to confirm or deny the suggestion;
if the suggestion is confirmed by the operator, applying a preprogrammed cooking parameter by the oven's control system.

12. The method of claim 11, wherein once the suggestion is confirmed a specified number of times, locking a specific suggestion and cooking parameter into the oven to prevent subsequent operators from engaging in operator interaction or confirmation.
